(19) United States
(12) Patent Application Publication
(10) Pub. No.: US 2026/0253975 A1
(43) Pub. Date: Aug. 27, 2026

(54) COATED CURRENT COLLECTORS

(71) Applicant: FORD GLOBAL TECHNOLOGIES, LLC, Dearborn, MI (US)

(72) Inventors: Zijie LU, Novi, MI (US); Wenhui ZHU, Northville, MI (US); Sathish RAJENDRAN, Farmington Hills, MI (US); Chansun PARK, Southfield, MI (US)

(21) Appl. No.: 19/060,257

(22) Filed: Feb. 21, 2025

(51) Int. Cl. H01M 10/42; H01M 4/04; H01M 4/66; H01M 10/0562

(52) U.S. Cl. CPC H01M 10/4235; H01M 4/0404; H01M 4/661; H01M 4/667; H01M 10/0562; H01M 2300/002; H01M 2300/0065

(57) ABSTRACT

A current collector for a solid-state battery is presented. The current collector includes a copper substrate coated with a continuous, close-packed polydopamine film. The polydopamine coating is formed to prevent chemical interaction between the copper substrate and solid electrolyte particles while maintaining electrical conductivity of the current collector within the solid-state battery.

### TECHNICAL FIELD

This disclosure relates to current collectors for solid-state batteries.

### BACKGROUND

Lithium-ion batteries utilize copper-based current collectors for anodes due to their high electrical conductivity and favorable mechanical properties. However, copper-based current collectors when used in sulfide-based solid-state batteries may react chemically.

### SUMMARY

A current collector for a battery is provided. The current collector includes a copper substrate and a polydopamine coating forming a continuous, close-packed film on the copper substrate. The polydopamine coating is formed to prevent chemical interaction between the copper substrate and solid electrolyte particles while maintaining the electrical conductivity of the current collector. The polydopamine coating may have a thickness between 5 nanometers and 20 nanometers. The polydopamine coating may have a porosity of less than 5%. The polydopamine coating may have an electrical conductivity between 1 S/cm and 100 S/cm. The polydopamine coating may also have a crosslinked polymer network. The polydopamine coating may be adhered to the copper substrate with a bond strength of at least 5 MPa.

A solid-state battery is provided. The solid-state battery includes a sulfide-based solid electrolyte and a current collector foil with a polydopamine layer chemisorbed onto the current collector foil. The polydopamine layer is to prevent ion diffusion through the polydopamine layer. The polydopamine layer may further inhibit lithium dendrite penetration. The polydopamine layer may have a thickness between 5 nanometers and 20 nanometers and may be partially oxidized. The sulfide-based solid electrolyte may include a lithium thiophosphate material. The polydopamine layer may be chemisorbed onto the current collector foil with an interfacial resistance of less than 50 Ohm/cm².

A method of forming a current collector foil is provided. The method includes immersing a copper foil in an alkaline buffer solution with dopamine hydrochloride to oxidize the copper foil and form a polydopamine-coated copper foil. The polydopamine-coated copper foil is then dried to form a coated current collector foil. The alkaline buffer solution may have a pH of 8.5. The alkaline buffer solution may include dopamine hydrochloride in a by volume amount of 2 mg/mL. The copper foil may be immersed in the alkaline buffer solution for at least 24 hours to allow for oxidative polymerization. The method may further include rinsing the polydopamine-coated copper foil with deionized water before drying. The drying process may involve vacuum drying. The method may also include partially carbonizing the coated current collector foil. The partial carbonization may be conducted in an argon environment at temperatures between 300 and 600° C.

### BRIEF DESCRIPTION OF THE DRAWINGS

FIG. 1 shows copper sulfide formation and pitting corrosion on an electrode;

FIG. 2 shows localized copper sulfide deposits and pitting on a copper substrate;

FIG. 3 is a graph comparing sheet resistance of different copper-based current collectors;

FIG. 4 shows voltage-capacity curves of copper-based current collectors in a half-cell;

FIG. 5 shows capacity retention and coulombic efficiency of copper-based current collectors over charge-discharge cycles;

FIG. 6 is a schematic diagram of a solid-state battery incorporating a polydopamine-coated copper current collector; and

FIG. 7 is a process flow diagram showing a method for forming a polydopamine-coated copper current collector.

### DETAILED DESCRIPTION

In accordance with this disclosure, detailed embodiments of electrode structures, manufacturing methods, and battery systems are disclosed herein. These embodiments are representative of an approach to solid-state battery performance through the modification of negative electrode current collectors. The figures and descriptions provided are illustrative and may not represent all possible variations or configurations. Certain features may be exaggerated or minimized to highlight particular aspects of the electrode assemblies and their formation processes. Thus, the specific structural and functional details disclosed are not intended to limit the scope, but rather to provide a foundational basis for those skilled in the art to implement various embodiments of the claimed subject matter.

Unless explicitly stated otherwise, all numerical values, measurements, percentages, weights, and similar quantitative parameters disclosed herein should be understood as being prefixed by the term “about.” This convention applies even when the term “about” is not explicitly used. The intent is to encompass variations arising from standard measurement techniques, manufacturing processes, material properties, and the inherent variability in the performance of the electrode structures and battery systems. For instance, when referring to a porosity of “10 to 50 percent,” this range should be interpreted as “about 10 to about 50 percent,” allowing for deviations that do not significantly alter the functionality or performance of the electrode assemblies or the overall battery system.

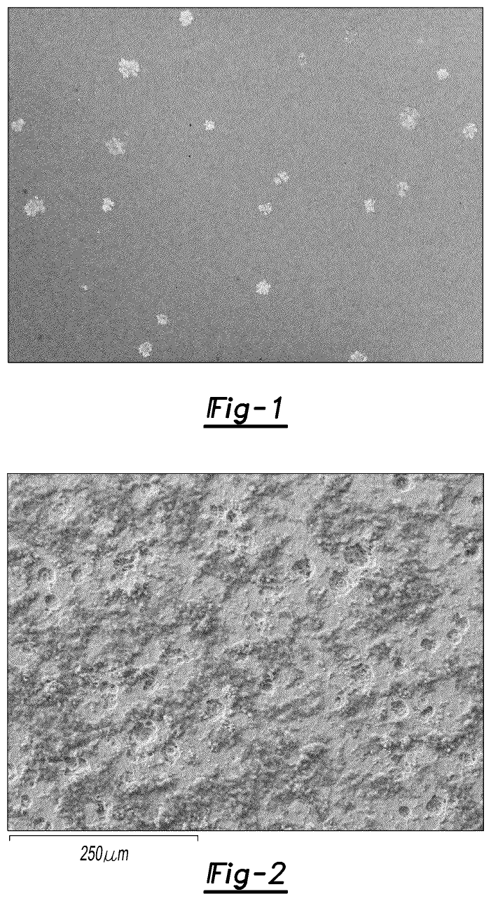

The chemical reactions between copper and sulfide electrolytes in sulfide-based solid-state batteries (SSBs) present a challenge for their performance and reliability. As shown in FIG. 1, these reactions may cause copper sulfide to form on a negative electrode and lead to pitting corrosion of the copper current collector, and as shown in FIG. 2, with copper sulfide formation and localized pitting observable on copper substrates. This corrosion may make conventional copper-based current collectors unsuitable for SSB applications, necessitating the development of alternative strategies to mitigate copper corrosion and preserve battery performance.

Attempts to address this have involved applying carbon coatings to copper current collectors to create a physical barrier between the sulfide electrolyte and the copper substrate. Carbon coatings, while partially effective, are inherently porous and cannot entirely prevent contact between the electrolyte and copper. This residual interaction may allow corrosion to persist.

Polydopamine, is a versatile biopolymer and can form dense, continuous thin films that adhere strongly to a wide range of substrates, including copper. Unlike carbon coatings, polydopamine may form a uniform and non-porous barrier that completely isolates the copper substrate from the sulfide electrolyte, this may effectively prevent the chemical reactions that lead to copper sulfide formation and pitting corrosion. Furthermore, polydopamine has semiconducting properties that may maintain the electrical conductivity of an SSB component.

In an example manufacturing environment, a thin film of polydopamine may be applied to a copper current collector to act as a durable protective layer. The polydopamine coating prevents unwanted chemical reactions and retains the mechanical and electrical properties of the copper current collector. Moreover, the electrical conductivity of the polydopamine coating may be increased through heat treatment. When the polydopamine-coated copper current collector is subjected to a controlled heat treatment process at temperatures ranging from 300 degrees Celsius (° C.) to 600° C. in an inert environment, the polydopamine film undergoes partial carbonization. This results in a heat-treated polydopamine-coated copper current collector that combines the protective properties of polydopamine with increased electrical conductivity.

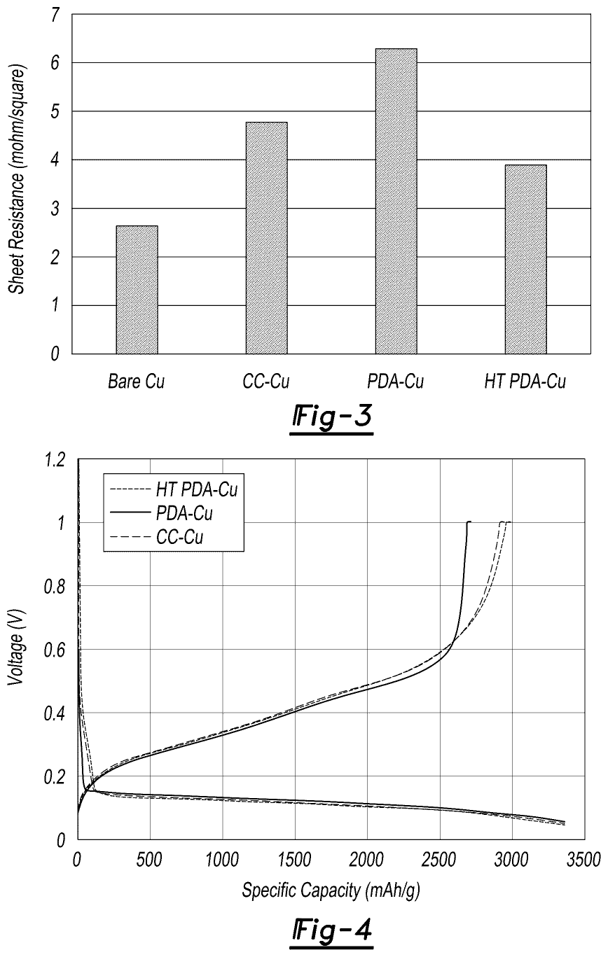

FIG. 3 shows a bar graph comparing the sheet resistance of various copper-based current collectors that may be used in battery applications. The x-axis categorizes four different types of current collectors, while the y-axis quantifies their respective sheet resistances in milliohms per square centimeter. The tested current collectors included bare copper (Bare Cu), carbon-coated copper (CC-Cu), pristine polydopamine-coated copper (PDA-Cu), and heat-treated polydopamine-coated copper (HT PDA-Cu), which was subjected to 600° C. for 2.5 hours to increase its conductivity.

The results indicate that Bare Cu exhibits the lowest sheet resistance, approximately 2.5 milliohms per square, as expected for an uncoated copper foil. CC-Cu, which includes a carbon coating, has a moderately higher sheet resistance of about 5 milliohms per square, suggesting that while the carbon layer may provide some interfacial stability benefits, it slightly increases electrical resistance. PDA-Cu, with a pristine polydopamine coating, demonstrates the highest sheet resistance at around 6.5 milliohms per square, indicating that the polydopamine layer impairs conductivity. However, heat treatment of the polydopamine-coated copper at 600° C. for 2.5 hours (HT PDA-Cu) effectively lowers the sheet resistance to approximately 4 milliohms per square, reducing it below that of carbon-coated copper. While polydopamine coatings increase resistance due to their insulating nature, their thinness, which may be less than 30 nanometers (nm), limits this effect to an approximate two and a half fold increase compared to Bare Cu. Additionally, heat treatment of polydopamine results in partial carbonization, and reduces resistance.

FIG. 4 shows a performance comparison of different current collectors in a silicon anode-based half-cell configuration with a solid electrolyte and lithium metal. The x-axis represents specific capacity in milliampere-hours per gram (mAh/g), while the y-axis shows voltage (V). The graph compares three current collector types: heat-treated polydopamine-coated copper (HT PDA-Cu), pristine polydopamine-coated copper (PDA-Cu), and carbon-coated copper (CC-Cu).

The experimental setup includes a silicon anode, a solid electrolyte, a conductive binder, and an additional binder. The cell has an areal capacity per square centimeter of 3 mAh/cm² and undergoes current-constant voltage cycling within a voltage range of 0.05 volts (V) to 1.0 V at 45° C. The HT PDA-Cu current collector enables the silicon anode to achieve slightly higher capacity and first-cycle coulombic efficiency than CC-Cu, due to its lower sheet resistance, which increases conductivity and reduces interfacial losses. In contrast, PDA-Cu has higher sheet resistance, leading to lower capacity and reduced coulombic efficiency, likely from increased polarization and energy losses. This comparison shows the role of current collector properties in silicon anode performance. Heat-treating polydopamine at 600° C. for 2.5 hours lowers resistance, increasing charge transport and battery efficiency. While pristine polydopamine provides current collector protection, its higher resistance may hinder performance.

FIG. 5 compares the capacity retention and coulombic efficiency of silicon anodes using three different current collectors: heat-treated polydopamine-coated copper (HT PDA-Cu), pristine polydopamine-coated copper (PDA-Cu), and carbon-coated copper (CC-Cu). The x-axis represents the cycle number, while the left y-axis shows the specific capacity in mAh/g and the right y-axis displays coulombic efficiency (%).

The HT PDA-Cu current collector has the highest capacity and best capacity retention, maintaining a stable specific capacity above 3000 mAh/g over multiple cycles. CC-Cu has slightly lower capacity retention but performs better than PDA-Cu. In contrast, PDA-Cu has the lowest capacity and capacity retention, with its specific capacity rapidly decreasing below 2500 mAh/g within the first few cycles. The rapid degradation of PDA-Cu suggests that its higher sheet resistance and interface stability may contribute to faster performance loss. These results also indicate that heat treatment of the polydopamine coating increases electrochemical performance by reducing resistance and increasing interfacial stability.

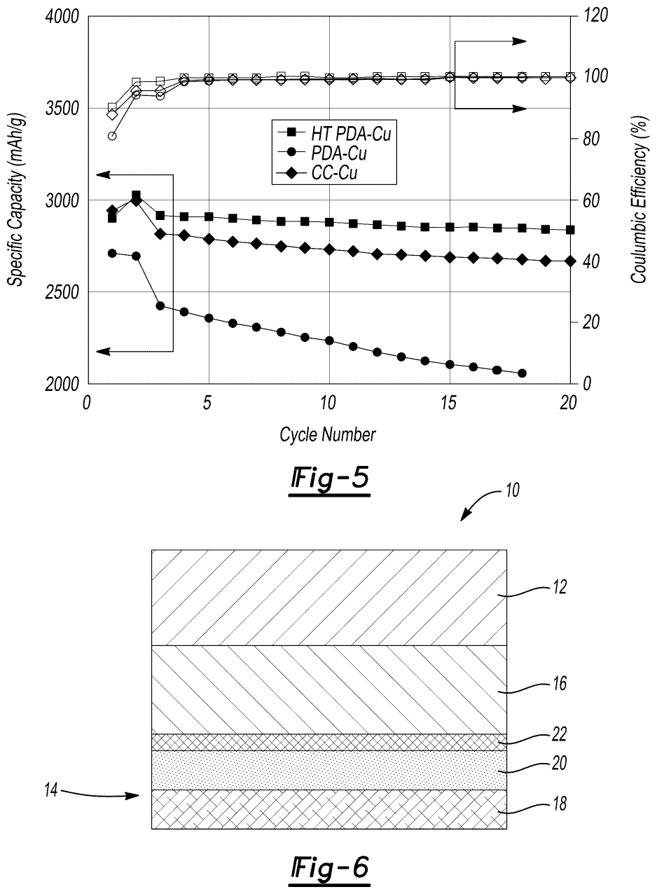

FIG. 6 shows a solid-state battery 10 which includes a positive electrode 12, a negative electrode 14, and a sulfide-based solid electrolyte 16 positioned between the electrodes. The negative electrode 14 includes a current collector 18 with a copper substrate 20 and a polydopamine coating 22 forming a continuous, close-packed film on the copper substrate 20. The polydopamine coating 22 is configured to prevent chemical interaction between the copper substrate 20 and the sulfide-based solid electrolyte 16 while maintaining the electrical conductivity of the current collector 18. The polydopamine coating 22 may have a thickness between 5 nm and 20 nm, with a porosity of less than 5%, and an electrical conductivity between 1 siemens per centimeter (S/cm) and 100 S/cm. Additionally, the polydopamine layer 22 may have a crosslinked polymer network. The polydopamine layer 22 may also adhere to the copper substrate 20 with a bond strength of at least 5 megapascals. The polydopamine coating 22 may further be chemisorbed onto the current collector 18 with an interfacial resistance of less than 50 ohms per square centimeter (Ohm/cm²) and may be partially oxidized.

The sulfide-based solid electrolyte 16, which may be made of a lithium thiophosphate material, facilitates lithium-ion transport between the positive electrode 12 and the negative electrode 14 while inhibiting lithium dendrite penetration. The positive electrode 12 may be made of a lithium-based transition metal oxide such as lithium nickel manganese cobalt oxide or lithium iron phosphate. The negative electrode 14 may further include a lithium metal layer or a lithium-alloy material such as lithium-tin or lithium-silicon. The battery 10 may also include additional interfacial layers, such as a lithium-phosphorous-oxynitride coating, to further stabilize a solid electrolyte interface between the negative electrode 14 and the sulfide-based solid electrolyte 16.

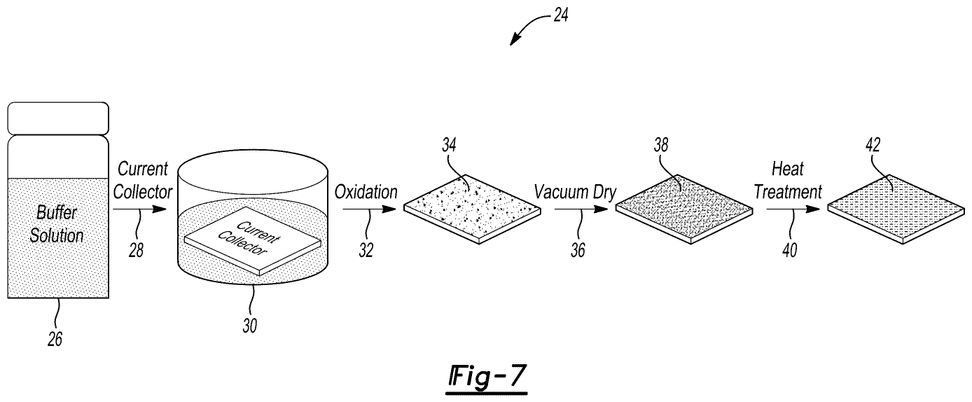

FIG. 7 shows a method 24 for forming a polydopamine-coated copper current collector, following a multi-step process involving oxidation, drying, and heat treatment. The method 24 begins with an alkaline buffer solution containing dopamine hydrochloride 26 and immersing a current collector 28 into a reaction vessel 30. This alkaline buffer solution containing dopamine hydrochloride 26 facilitates oxidative polymerization of dopamine, forming a polydopamine coating on the current collector 28. The alkaline buffer solution containing dopamine hydrochloride 26 may specifically contain 10 millimole of tris buffer with a pH of 8.5 and 2 milligrams per milliliter (mg/mL) dopamine hydrochloride The current collector 18 may remain immersed in the reaction vessel 30 for a duration of at least 24 hours for complete polydopamine coating.

Following oxidation 32, the polydopamine-coated current collector 34 may be subjected to an optional rinsing step with deionized water remove residual reactants. The oxidation 32 may also be carried out for a period of 24 hours. The polydopamine-coated current collector 34 then undergoes vacuum drying 36 to eliminate moisture, to form a dried polydopamine-coated current collector 38. The vacuum drying 36 may be done at 80° C.

The dried polydopamine-coated current collector 38 undergoes heat treatment 40, which may be done in an argon environment at temperatures between 300° C. and 600° C., resulting in partial carbonization of the polydopamine layer. This process increases the conductivity of the polydopamine coating and produces a heat-treated polydopamine-coated current collector 42.

While the specific embodiments of the electrode structures, methods of forming such structures, and the resulting battery systems have been described in detail, these embodiments are not exhaustive of all potential configurations. The language used in this specification is intended for descriptive purposes and not as a limitation of the invention's scope. Modifications and variations may occur without departing from the core inventive concepts described herein. Additionally, the features and elements of various embodiments disclosed may be combined in novel ways to form additional embodiments within the scope of the claimed subject matter, even if such combinations are not explicitly detailed in this specification.

What is claimed is:

1. A current collector for a battery comprising:
a copper substrate; and
a polydopamine coating forming a continuous, close-packed film on the copper substrate configured to prevent chemical interaction between the copper substrate and solid electrolyte particles and to maintain electrical conductivity of the current collector.

2. The current collector of claim 1 wherein the polydopamine coating has a thickness between 5 nanometers and 20 nanometers.

3. The current collector of claim 1 wherein the polydopamine coating has a porosity of less than 5%.

4. The current collector of claim 1 wherein the polydopamine coating has an electrical conductivity between 1 S/cm and 100 S/cm.

5. The current collector of claim 1 wherein the polydopamine coating has a crosslinked polymer network.

6. The current collector of claim 1 wherein the polydopamine coating is adhered to the copper substrate with a bond strength of at least 5 MPa.

7. A solid-state battery comprising:
a sulfide-based solid electrolyte; and
a current collector foil with a polydopamine layer chemisorbed onto the current collector foil and configured to prevent ion diffusion through the polydopamine layer.

8. The solid-state battery of claim 7 wherein the polydopamine layer has a thickness between 5 nanometers and 20 nanometers.

9. The solid-state battery of claim 7 wherein the polydopamine layer is further configured to inhibit lithium dendrite penetration.

10. The solid-state battery of claim 7 wherein the polydopamine layer is partially oxidized.

11. The solid-state battery of claim 7 wherein the sulfide-based solid electrolyte comprises a lithium thiophosphate material.

12. The solid-state battery of claim 7 wherein the polydopamine layer is chemisorbed onto the current collector foil with an interfacial resistance of less than 50 Ohm/cm².

13. A method of forming a current collector foil comprising:
immersing a copper foil in an alkaline buffer solution with dopamine hydrochloride to oxidize the copper foil and form a polydopamine-coated copper foil; and
drying the polydopamine-coated copper foil to form a coated current collector foil.

14. The method of claim 13 wherein the alkaline buffer solution has a pH of 8.5.

15. The method of claim 13 wherein the dopamine hydrochloride has a by volume presence of 2 mg/mL in the alkaline buffer solution.

16. The method of claim 13 wherein a duration of the immersing is for at least hours to allow for oxidative polymerization.

17. The method of claim 13, further comprising rinsing the polydopamine-coated copper foil with deionized water before the drying.

18. The method of claim 13 wherein the drying is vacuum drying.

19. The method of claim 13, further comprising partially carbonizing the coated current collector foil.

20. The method of claim 19 wherein the partially carbonizing is done in an argon environment at temperatures between 300 and 600 ° C.
